(19) United States
(12) Patent Application Publication
(10) Pub. No.: US 2015/0220055 A1
(43) Pub. Date: Aug. 6, 2015

(54) Device for the Projection of Images, at Point of Sales, Simulating a Holographic Image

(71) Applicant: Reinaldo Waisman, Rio De Janeiro (BR)

(72) Inventor: Reinaldo Waisman, Rio De Janeiro (BR)

(21) Appl. No.: 14/117,184

(22) PCT Filed: May 3, 2013
(86) PCT No.: PCT/BR13/00143

§ 371 Date: Nov. 12, 2013

(30) Foreign Application Priority Data
Jul. 31, 2012 (BR) BR20 2012019055-4

(51) Int. Cl. G03H 1/00; G09F 19/18

(52) U.S. Cl. CPC G03H 1/0005; G09F 19/18; G03H 2001/0055

(57) ABSTRACT

The present application for a patent of utility model, an image projection equipment, in points of sale, simulating holography, aims to provide a new way to interact with consumers in points of sales, making the holographic simulation of an image related to the product to be marketed, have interactivity with the consumer, the moment he gets in that space where the product is exposed, as for example, supermarket gondola, branches of all types, shop Windows and any other form and place of marketing.

Are already known several projection equipment, and various forms of use, using screens, walls, and using synchronized sound output with the images, the screens are typically hung by wire, canvas laid down on walls and others, and possess at least one of their white faces, or projections made directly on walls, which are static plans, besides being too big, and with that demand large structures, requiring fit computers, projector and/or televisions, and a large space in the markets and shops, which becomes very expensive and difficult handling of, requiring several people to assemble, operate and dismantle all equipment.

The present application for a patent of utility model, an image projection equipment, in points of sale, simulating holography, aims to provide a new way to interact with consumers in points of sales, making the holographic simulation of an image related to the product to be marketed, have interactivity with the consumer, the moment he gets in that space where the product is exposed, as for example, supermarket gondola, branches of all types, shop Windows and any other form and place of marketing.

Are already known several projection equipment, and various forms of use, using screens, walls, and using synchronized sound output with the images, the screens are typically hung by wire, canvas laid down on walls and others, and possess at least one of their white faces, or projections made directly on walls, which are static plans, besides being too big, and with that demand large structures, requiring fit computers, projector and/or televisions, and a large space in the markets and shops, which becomes very expensive and difficult handling of, requiring several people to assemble, operate and dismantle all equipment.

Seeking a more playful to cause greater impact to consumers, this “image projection equipment, in points of sale, simulating a holography”, object of this application for a patent of utility model, should be used in a location where several products are placed side-by-side for sale, so that it can be placed so that the projector of image and audio stay hidden behind the products only the rod and the projection screen the view of the consumer, and the base of the projector, the stem and the fabric is made of a transparent material, preferably acrylic, being an extremely simple equipment, small and portable, which requires only a power source (110V-220V), and it occupies at the points of sale 10 cm from the front of a supermarket gondola or the equivalent of a row of 5 cans of soda, has the advantage to simulate a holography which is moving with music and voiceover, as was in the air in front of the products being sold, since at the base, is attached to a projector image and audio which is hidden on the shelf behind the products and the rod protrudes forward from the shelf or gondola, securing the screen in the air in front of the shelf seeming that this loose in the air.

The screen is attached to the stem by means of screws, since the same varies according to the projection, depending on the product is made a screen in transparent material, preferably in acrylic, which is clipped in the shape of the character or product being advertised or offered on the site, for example: in the form of a soda can, a box of milk, a character who is related to the product to be marketed, where will be designed promotional media.

The “equipment for projection of images, in points of sale, simulating a holography”, consists of a image projector and any audio, which can be fixed on the trail which lies at the base of the equipment, which has an adjustment to position the project, both in the left direction, back and forth and tilt upwards or downwards, so that the image is designed to accurately on the screen. This base has in one of his sides an extension, where the screen will be fixed, preferably by means of two screws.

The drawings show the attachments “equipment for projection of images, in points of sale, simulating a holography”, object of the present patent in which:

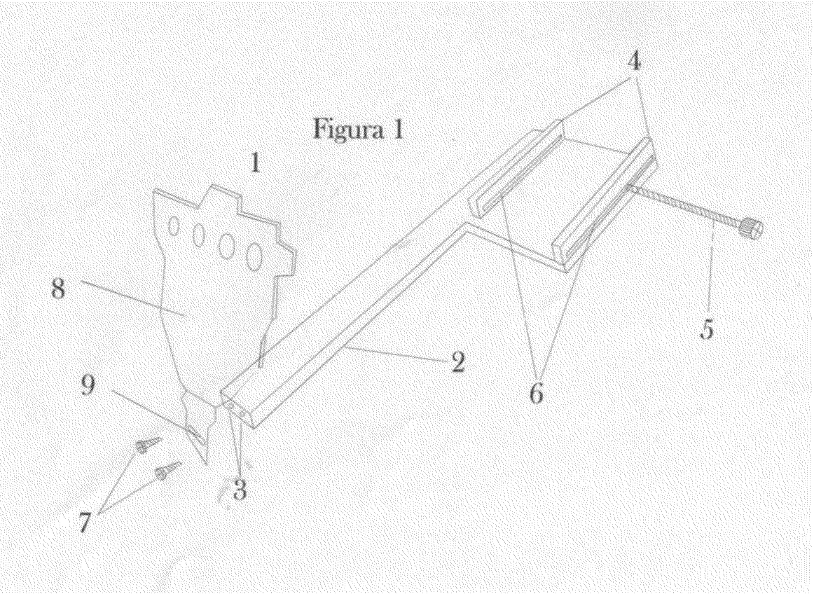

FIG. 1—perspective view of the projection equipment in points of sale, simulating a holography ″.

1—projection equipment in points of sale, simulating a holography.

2—screen fixing rod (8).

3—holes for the screws (7), that will fix the screen (8).

4—two side walls (6) to fit the projector.

5—screw for positioning of the projector, which allows stay ahead or more ago.

6—tear, so that the screw (5), can go forward or backward, depending on the position of the projector.

7—screen fixing bolts (8) rod (2) through the holes (3).

8—screen for projection.

9—tear fabric regulator (8) which allows the lateral displacement, to center the image.

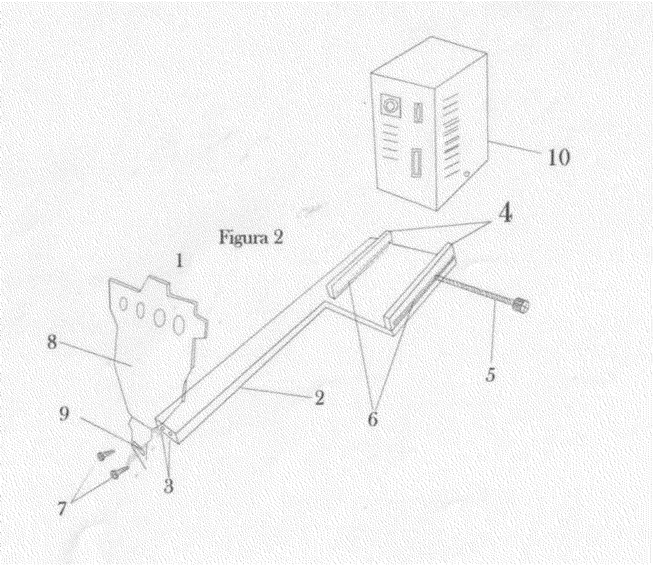

FIG. 2—perspective view of the projection equipment in points of sale, simulating a holography ″,

1—projection equipment in points of sale, simulating a holography.

2—screen fixing rod (8).

3—hole for the screws (7), that will fix the screen (9).

4—two side walls (6) to fit the projector.

5—screw for positioning of the projector, which allows stay ahead or more ago.

6—tear, so that the screw (5), can go forward or backward, depending on the position of the projector.

7—screen fixing bolts (8) rod (2) through the holes (3),

8—screen for projection.

9—tear fabric regulator (8) which allows the lateral displacement, to center the image.

10—illustration of a projector (10), in position to be fixed on the side walls (6).

1- “EQUIPMENT for PROJECTION of IMAGES, in points of SALE, simulating a HOLOGRAPHY”, characterized by holographic projections, using simulated equipment (1), as shown in FIG. 1, composed of a stem (2) fixing of the screen (8), which contains (3) holes for the screws (7), that will fix the screen (8), two walls (4) to fit the projector (10), screw (5) to position the projector, RIP (6) so that the screw (5) to position the projector (10), fabric (8) in transparent material and clipped as the product announced, being the same positioned by RIP (9).

2- “EQUIPMENT for PROJECTION of IMAGES, in points of SALE, simulating a HOLOGRAPHY”, characterized by the equipment (1), it can be used on shelves, shelves and the like, simulating a projection holografica.

3- “EQUIPMENT for PROJECTION of IMAGES, in points of SALE, simulating a HOLOGRAPHY”, characterized by screen (8), be in made in transparent material, preferably in acrylic, and varying in its format, as the propaganda presented.
